(19) United States
(12) Patent Application Publication
(10) Pub. No.: US 2020/0107986 A1
(43) Pub. Date: Apr. 9, 2020

(54) DEVICE FOR SEXUAL STIMULATION

(71) Applicant: Shane Murray, Saskatoon (CA)

(72) Inventor: Shane Murray, Saskatoon (CA)

(21) Appl. No.: 16/154,073

(22) Filed: Oct. 8, 2018

(51) Int. Cl. A61H 19/00

(52) U.S. Cl. CPC A61H 19/34; A61H 23/02; A61H 19/50; A61H 19/40

(57) ABSTRACT

A device for stimulation, the device comprising a hollow body having a first end and a second end, wherein a first connection mechanism is located distal to the first end and the second end has an opening to an interior cavity of the hollow body, a handle attached to the first connection mechanism, a motor positioned within the interior cavity of the hollow body, and a lower panel mechanically secured to the motor, wherein when the motor is activated the lower panel moves in a predetermined pattern.

### BACKGROUND OF THE INVENTION

The present invention relates to a vibratory device, and more particularly to a stimulation device for erogenous zones either through either direct contact or over clothes.

The erogenous zones of the human body can be stimulated with a variety of tools and through a variety of methods. Many types of sexual stimulation devices are available to allow users for achieving sexual satisfaction by stimulation of erogenous zones. Some of these devices are operated manually while others may include vibrating mechanism to also provide vibrations for application on the skin primarily in crotch area. The sexual stimulation devices employing vibrating mechanism can be useful for stimulating both male and female anatomy. For stimulating erogenous zones, the vibrations may be applied externally to the penis, clitoris and internally to vagina. For example, vibrators are used to apply a stimulus to a particular area of the skin by direct contact.

Many people are anorgasmia (the medical term for regular difficulty reaching orgasm) is a widespread medical problem for many sexually active men and women of all ages. For those that have difficulty reaching an orgasm, most require additional external stimulation. The intensity and frequency of the orgasms, and the amount of stimulation needed to trigger orgasms varies considerably. However, this form of stimulation can lead to irritations or inflammations of the skin. Also, direct contact of the genital area with such tools for individual reasons of hygiene or due to personal reservations, for example, may not be desired. Additionally, some of these devices can be used only with the male genital organ or female genital organ. Other devices have to be used by directly contacting the male genital organ or female genital organ and cannot function from over the clothes. Also, the vibration provided by some of these devices is very high and interferes with the general massage or erogenous pleasure.

Many men experience erectile dysfunction. Chemical agents can be administered by injection into or near penis, or they can be taken orally, compare the medicament “Viagra”. However, chemical remedies are burdened with adverse effects, and injections will feel unpleasant for many persons. Among the commonly known mechanical erection aids are vacuum pumps for obtaining erection and tightening devices e.g. round the root of the penis for maintaining an obtained erection. Typically, vibration type stimulation devices do not work for men with these types of issues.

Therefore, it is desired to have a device and a method of operation which provides the user adjust the stimulation either directly on the skin or over the clothes of the erogenous zone(s). Also, it is desired to allow use of the device for stimulation of erogenous sites as well as general massage of skin.

### SUMMARY

The present invention is directed to a device and method of using the same wherein the device has a device for stimulation, the device comprising a hollow body having a first end and a second end, wherein a first connection mechanism is located distal to the first end and the second end has an opening to an interior cavity of the hollow body, a handle attached to the first connection mechanism, a motor positioned within the interior cavity of the hollow body, and a lower panel mechanically secured to the motor, wherein when the motor is activated the lower panel moves in a predetermined pattern.

In accordance with another embodiment, the device includes a device for stimulation, the device comprising, a hollow body having a first end and a second end, wherein a first connection mechanism is located distal to the first end and the second end has an opening to an interior cavity of the hollow body, an ergonomically formed handle detachably connected to the first connection mechanism, wherein the connection provides for electrical and mechanical connections, a control mechanism displayed on the ergonomically formed handle, a motor positioned within the interior cavity of the hollow body and electrically connected to the control mechanism, a lower panel mechanically secured to the motor, and a flexible skirt secured between the second end of the hollow body and the lower panel, wherein a water tight seal is formed.

It is the inventor's belief that using this device to stimulate the erogenous zones will enhance sexual stimulation and increase the likelihood and intensity of orgasms.

### BRIEF DESCRIPTION OF THE DRAWINGS

FIG. 1 depicts an isometric view of a stimulation device, in accordance with one embodiment of the present invention.

FIG. 2 depicts an isometric view of the stimulation device, in accordance with one embodiment of the present invention.

FIG. 3 depicts a side view of the stimulation device, in accordance with one embodiment of the present invention.

FIG. 4 depicts an isometric view of the stimulation device with a cover secured to the lower plate, in accordance with one embodiment of the present invention.

FIG. 5 depicts a schematic of the electrical components of the stimulation device, in accordance with one embodiment of the present invention.

### DETAILED DESCRIPTION OF THE INVENTION

The present invention provides a device for assisting with erectile dysfunction, anorgasmia, enhancing sexual stimulation of one's erogenous zones, or massaging one's skin. These benefits can be achieved through either direct contact with the one's skin or through their clothing. Through the use of the interchangeable attachments, the user can modify or adjust the texture of the portion of the device which is in contact with their person and also allow for the adjustment of the movement of the device.

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances and are part of the present invention. Thus, the following description is provided as illustrative of the principle of the present invention.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

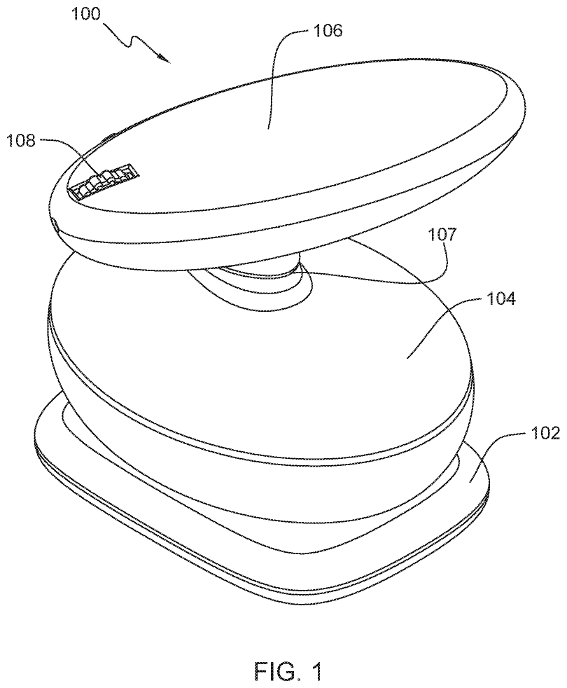

FIG. 1 depicts an isometric view of a stimulation device 100, in accordance with one embodiment of the present invention. The simulation device is comprised of a lower plate 102, main body 104, and handle 106.

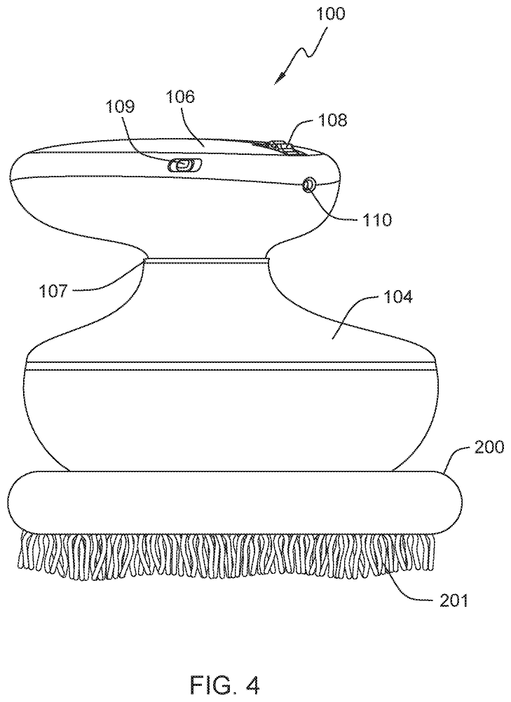

The lower plate 102 provides the stimulation for the user through various movements of the lower plate 102 against the user's skin or clothing. The lower plate 102 may be, in various embodiments, designed to, vibrate, oscillate, spasm, quiver, massage, rotate, or otherwise move in a predetermined pattern. The size, shape, and design of the lower plate 102 is variable based on the intended purpose of the lower plate 102. In the depicted embodiment, the lower plate 102 is a rectangular shape with a flat lower surface 103. In additional embodiments, that lower surface 103 may have various curves, angles or multiple surfaces. The lower plate 102 is typically formed from a hard material, to provide structural rigidity to the device. In some embodiments, the lower surface 103 may have various coatings or covers 200 to provide various textures for the user. For example, Cyberskin® may cover the lower plat 102 to provide a skin-like texture for the user (shown in FIG. 4). In the depicted embodiment, the cover 200 has a plurality of extensions (e.g. tassels) to provide a heightened degree of sensitivity to the stimulation device 100. The tassels 201 may be of varying shape, quantity, material, or the like. In the depicted embodiment, the cover 200 and the tassels 201 are a unitarily designed element.

Various covers may also be attached or secured to the lower plate 102 to provide a greater variety to texture and stimulation. In FIG. 4, a cover 200 is shown secured to the lower plate 102. The cover 200 provides the adjustability of various textures, materials, and stimulation techniques for the user and is easily replaced and removed through an adjustable securing means. In the depicted embodiment, the cover 200 has a plurality of tassels 201 connected to the cover 200 to provide a heightened sensitivity when the simulation device 100 is used. The tassels 201 may be made from various materials and may be integrated into the cover 200. In some embodiments, the tassels 201 are removable from the cover 200. The cover 200 may be secured to the lower plate 102 through, but not limited to, a fitted design (shown in the depicted embodiment), a removable attachment means such as hook and loop style fasteners, or other removable securing means know to those skilled in the art. In some embodiments, various types of locks such as bolt style locks, pressure locks, snap locks, and the like are used.

In some embodiments, the cover 200 (and the tassels 201 if present) is made from a soft elastomeric material that is intended to emulate the feel of human skin, is warm and soft to touch. For example, a soft elastomeric material similar to CyberSkin® are available in the market by names Ultraskin™, Eroskin™, Softskin™, SoftTouch™, Cyber Jel-lee™, New Supersoft™, Futurotic®, and URL™ (Ultra Realistic 3.0). The cover 200 may have various protrusions, extensions, or projections to further increase the stimulation effects of the device 100. The cover 200 can be optionally lubricated with oil for creating stimulation and sensation to the skin being massaged with the stimulation device 100 with the cover 200 in contact with the skin. The present invention may also use other material made of IE jelly, rubber, silicone and the like in place of soft elastomeric material. The soft elastomeric material of the cover 200 are used in different textures and colors with the stimulation device 100 of the present invention.

Through the connection method with the body 104, the lower plate 102 is able to move independent of the body 104, so that when activated, the body 104 and handle 106 remain substantially stationary and only the lower plate 102 (and cover 200 if attached) vibrate or move. In some embodiments, a flexible skirt 110 forms a water tight seal is formed between the lower plate 102 and the body 104. The flexible skirt 110 is used to provide the range of movement for the lower panel 102 while protecting the internal components from damage. The flexible skirt 110 covers the connection point of the lower plate 102 and the body 104. In additional embodiments, the lower plate 102 is detachable from the body 104.

The body 104 provides the housing and protection for the motor(s), power source(s), and other electrical components. An arrangement of electronic and/or electromechanical components as is known in the art for generating such motion, including those arrangements used in conjunction with vibrators and other sex toys. These components may include a motor or solenoid having an actuator for generating vibrations or the other motion, an electronic controller, and a power source, such as batteries (chargeable or rechargeable), electrically coupled to the motor or solenoid via the controller. The motors can be adjusted to different speeds, intensities and patterns of vibration or massage, for example. The body may have various shapes and contours to provide both aesthetic and ergonomic benefits to the user.

The body 104 has a connection member 107, wherein the handle 106 attached to the body 104. The connection member 107 provides a location for the handle 106 to detachably secure to the body 104. The releasable attachment means provides a mechanical and electrical connection between the body 104 and the handle 106. In some embodiments, the handle 106 and the body 104 are a unitary element and designed a single component. In some embodiments, the handle 106 may rotatable the connection member 107. In the embodiments, where the handle 106 is able to rotate, a locking mechanism maybe incorporated into the design to allow the user to secure the handle 106 in their desired position relative to the lower plate 102.

The handle 106 provides the user with access to the controls of the stimulation device 100 as well as the means to control the location and position of the stimulation device 100. The handle 106 is designed to ergonomically fit within the user's hand. In the depicted embodiment, the handle 106 is designed to be held in the palm of the user's hand and their fingers warp around the sides of the handle 106. The handle 106 may be designed in various shapes and with various coatings to improve the user's ability to firmly grasp the handle 106.

Positioned on the handle 106 is the stimulation control 108, the power control switch 109, and an electrical connection 110. ally fit in the user's hand. The stimulation control 108 is used to adjust the vibration or movement of the lower panel 102 to the user's preferred speed, pattern, or setting. In some embodiments, additional controls are present wherein one controls the intensity of the vibration and another control provides the predetermined movement pattern of the lower plate 102. The integrated electronic components may have preprogrammed patterns, settings, or speeds based on the motor. In the depicted embodiment, the stimulation control 108 is a wheel which is set within the handle 106 with a portion protruding beyond the surface of the handle 106 to allow the user to adjust the stimulation control 108 with one finger. The power control switch 109 is used to turn on or off the motor. In some embodiments, various other settings may be adjustable through the power control switch 109, such as intensity of the movement, or range of travel of the lower plate 102 when active. The electrical connection 110 provides an access port to charge an internal battery (if present) or to provide power to the electrical components.

In some embodiments, the handle 106 or the lower plate 102 are extendable and retractable for adjustability. The lower plate 102 may be adjustable to provide a greater coverage area if desired.

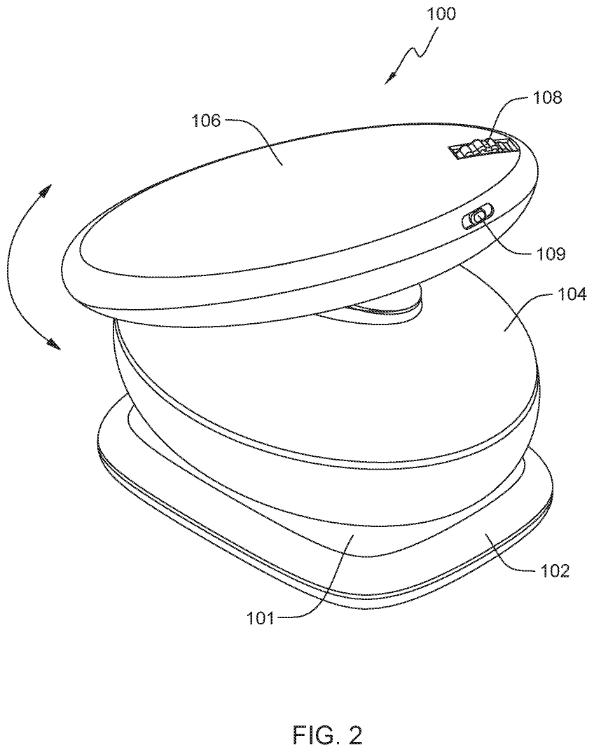

FIG. 2 depicts an isometric view of the stimulation device 100, in accordance with one embodiment of the present invention. In the depicted embodiment, the handle 106 is shown rotated to provide an alternative setup for a user.

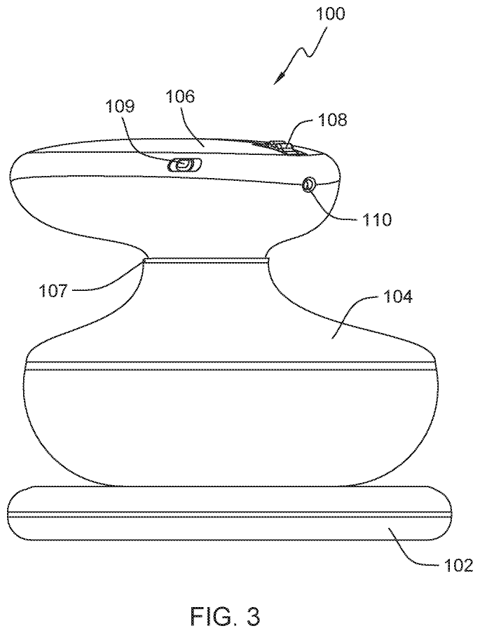

FIG. 3 depicts a side view of the stimulation device 100, in accordance with one embodiment of the present invention. In the depicted embodiment, the stimulation control 108, the power control 109, and the electrical connection 110 is shown on the handle 106. In various embodiments, these controls and connections can be located on the body 104 or different positioned on the handle 106 to provide an ergonomic and comfortable design. The lower plate 102 is shown with a cover 200, wherein the cover 200 is removable and is pressure fitted around the lower base 102 to provide a secure fit. In additional embodiments, various types of fasteners can be employed to secure the cover 200 to the lower base 102.

FIG. 4 depicts an isometric view of the stimulation device 100 with a cover 200, in accordance with one embodiment of the present invention. In the depicted embodiment, the cover 200 is shown having a texture to provide a different feel to the user. Various cover 200 designs may be used.

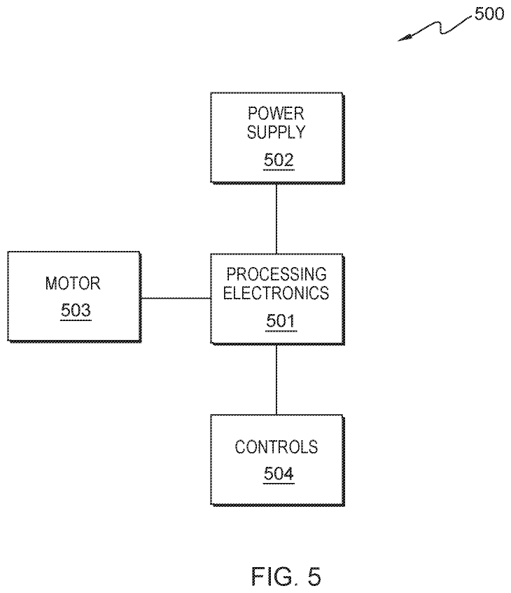

FIG. 5 depicts a schematic diagram of the electrical components of the stimulation device 100, in accordance with one embodiment of the present invention. Stimulation device 100 includes the motor 503, processing electronics 501, a power supply 502, and the controls 504 (e.g. 108 and 109). The motor 503 provides the vibration or oscillation of the lower panel 102. The motor 503 is in electrical and mechanical communication with the processing electronics 501. The motor 503 may each have a vibrating motor or may share a vibrating motor, and may be configured to provide a pleasurable sensation to a user or to provide haptic feedback to a user, the haptic feedback being in response to user input through controls 109. The actuation motor 504 controls the movement of the lower plate 102.

Stimulation device 100 is shown to include stimulation control 108 communicating with the, processing electronics 501. The stimulation control 108 may include any suitable user interface, e.g., buttons, toggles, switches, an electro-acoustic transducer configured to receive voice commands, a touch sensitive display, etc. For example, processing electronics 501 may be configured to provide power to the power supply 502 through the power switch 109 and communicate the users use of the stimulation control 108 to the various vibration settings and movement patterns of the lower plate 102. Stimulation device 100 is further shown to include a power supply 502. Power supply 502 is configured to provide electrical power to stimulation device 100 and components thereof. According to an exemplary embodiment, stimulation device 100 is configured to be powered by a batteries located in the main body 104. According to other embodiments, stimulation device 100 may use other voltages, a rechargeable battery, or may be plugged into utility power supply.

The various elements of the simulation device 100 may be made from, but not limited to polyethylene, polyethylene terephthalate, high-density polyethylene, polypropylene, polystyrene, polyvinyl chloride, polyurethane, poly carbonate, polybutylene terephthalate, acrylonitrile styrene acrylate, acrylics, aluminum, steel, cooper, various other metals, a combination of plastics and metals, or the like.

In one embodiment, a wireless remote may also be included to enable the user to remotely control the power and/or operation of these components. Other components could be included within the device, such as a component to regulate the temperature via heating or cooling the device

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A device for stimulation, the device comprising:
a hollow body having a first end and a second end, wherein a first connection mechanism is located distal to the first end and the second end has an opening to an interior cavity of the hollow body;
a handle attached to the first connection mechanism;
a motor positioned within the interior cavity of the hollow body; and
a lower panel mechanically secured to the motor, wherein when the motor is activated the lower panel moves in a predetermined pattern.

2. The device for stimulation of claim 1, the device further comprising; a flexible skirt secured between the interchange of the second end of the hollow body and the lower panel, wherein a water tight seal is formed.

3. The device for stimulation of claim 1, wherein the first connection mechanism provides for rotation about a center axis of the first end of the hollow body.

4. The device for stimulation of claim 1, further comprising a cover, wherein the cover is detachably secured around the lower panel.

5. The device for stimulation of claim 4, wherein the cover has at least one textured pattern disposed on an exterior surface of the cover.

6. The device for stimulation of claim 4, wherein the cover is secured to the lower panel through a detachable fastener.

7. The device for stimulation of claim 1, further comprising a control mechanism, wherein the control mechanism is in communication with the motor.

8. The device for stimulation of claim 1, wherein the first connection mechanism is detachable.

9. The device for stimulation of claim 7, wherein the control mechanism is configured to control the motor based on a predetermined movement pattern.

10. The device for stimulation of claim 4, wherein the cover is a silicone rubber.

11. The device for stimulation of claim 1, wherein the lower panel is detachable from the motor.

12. The device for stimulation of claim 1, wherein the motor is able to oscillate and vibrate.

13. The device for simulation of claim 3, further comprising a locking mechanism integrated into the first connection mechanism.

14. The device for stimulation of claim 8, wherein the detachable first connection mechanism provides electrically connects the control mechanism and the motor when attached to the body.

15. A device for stimulation, the device comprising:
a hollow body having a first end and a second end, wherein a first connection mechanism is located distal to the first end and the second end has an opening to an interior cavity of the hollow body;
an ergonomically formed handle detachably connected to the first connection mechanism, wherein the connection provides for electrical and mechanical connections;
a control mechanism displayed on the ergonomically formed handle;
a motor positioned within the interior cavity of the hollow body and electrically connected to the control mechanism;
a lower panel mechanically secured to the motor; and
a flexible skirt secured between the second end of the hollow body and the lower panel, wherein a water tight seal is formed.

16. The device for stimulation of claim 15, further comprising a plurality of tassels attached to the flexible skirt.

17. The device for stimulation of claim 16, wherein the plurality of tassels and the flexible skirt are a unitarily designed element.
